(19) United States
(12) Patent Application Publication
(10) Pub. No.: US 2025/0294430 A1
(43) Pub. Date: Sep. 18, 2025

(54) MONITORING PROCEDURE FOR DYNAMICALLY ADAPTED SYNCHRONIZATION SIGNAL BLOCKS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Ahmed Omar Desouky ALI, Santa Clara, CA (US)

(21) Appl. No.: 18/608,472

(22) Filed: Mar. 18, 2024

(51) Int. Cl. H04W 48/08; H04L 1/00; H04W 72/04

(52) U.S. Cl. CPC H04W 48/08; H04L 1/0013; H04W 72/04

(57) ABSTRACT

Methods, systems, and devices for wireless communications are described. A user equipment (UE) may receive a first message indicating a configuration for multiple synchronization signal blocks (SSBs) and a second message indicating an activation or a deactivation of at least one SSB of the configuration. The at least one SSB may be associated with a first set of resources at least partially overlapping a second set of resources associated with a downlink transmission. The UE may perform a monitoring procedure according to rate matching rules, where the rate matching rules may be based on the activation or deactivation of the SSB, the overlapping resources, or both. For example, the UE may perform rate matching, refrain from performing rate matching, monitor for a downlink transmission, or refrain from monitoring for a downlink transmission according to the rate matching rules.

### FIELD OF TECHNOLOGY

The following relates to wireless communications, including monitoring procedure for dynamically adapted synchronization signal blocks (SSBs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support monitoring procedure(s) for dynamically adapted synchronization signal blocks (SSBs). For example, the described techniques enable a user equipment (UE) to receive a first message indicating a configuration for multiple SSBs and receive a second message indicating an activation or a deactivation of at least one SSB of the configuration. As an example, the second message may activate or deactivate the at least one SSB, which may be associated with a first set of resources at least partially overlapping a second set of resources associated with a downlink transmission. For instance, the first set of resources associated with the SSB may overlap with the second set of resources associated with a physical downlink shared channel (PDSCH), a semi-persistent scheduling (SPS)-PDSCH, a physical downlink control channel (PDCCH), or the like. The UE may perform a monitoring procedure according to rate matching rules, where the rate matching rules may be based on the activation or deactivation of the SSB, the overlapping resources, or both. For example, the UE may perform rate matching, refrain from performing rate matching, monitor for a downlink transmission, or refrain from monitoring for a downlink transmission according to the rate matching rules.

A method for wireless communications by a UE is described. The method may include receiving a first message indicating a configuration for a set of multiple SSBs, receiving a second message indicating an activation or a deactivation of at least one SSB of the set of multiple SSBs of the configuration, where the at least one SSB is associated with a first set of resources at least partially overlapping with a second set of resources allocated for a downlink transmission, and performing a monitoring procedure according to one or more rate matching rules, where the one or more rate matching rules are based on the activation or the deactivation of the at least one SSB and based on the first set of resources at least partially overlapping with the second set of resources allocated for the downlink transmission.

A UE for wireless communications is described. The UE may include one or more memories storing processor executable code, and one or more processors coupled with the one or more memories. The one or more processors may individually or collectively be operable to execute the code to cause the UE to receive a first message indicating a configuration for a set of multiple SSBs, receive a second message indicating an activation or a deactivation of at least one SSB of the set of multiple SSBs of the configuration, where the at least one SSB is associated with a first set of resources at least partially overlapping with a second set of resources allocated for a downlink transmission, and perform a monitoring procedure according to one or more rate matching rules, where the one or more rate matching rules are based on the activation or the deactivation of the at least one SSB and based on the first set of resources at least partially overlapping with the second set of resources allocated for the downlink transmission.

Another UE for wireless communications is described. The UE may include means for receiving a first message indicating a configuration for a set of multiple SSBs, means for receiving a second message indicating an activation or a deactivation of at least one SSB of the set of multiple SSBs of the configuration, where the at least one SSB is associated with a first set of resources at least partially overlapping with a second set of resources allocated for a downlink transmission, and means for performing a monitoring procedure according to one or more rate matching rules, where the one or more rate matching rules are based on the activation or the deactivation of the at least one SSB and based on the first set of resources at least partially overlapping with the second set of resources allocated for the downlink transmission.

A non-transitory computer-readable medium storing code for wireless communications is described. The code may include instructions executable by one or more processors to receive a first message indicating a configuration for a set of multiple SSBs, receive a second message indicating an activation or a deactivation of at least one SSB of the set of multiple SSBs of the configuration, where the at least one SSB is associated with a first set of resources at least partially overlapping with a second set of resources allocated for a downlink transmission, and perform a monitoring procedure according to one or more rate matching rules, where the one or more rate matching rules are based on the activation or the deactivation of the at least one SSB and based on the first set of resources at least partially overlapping with the second set of resources allocated for the downlink transmission.

In some examples of the method, UEs, and non-transitory computer-readable medium described herein, receiving the second message may include operations, features, means, or instructions for receiving the second message indicating the activation or the deactivation of the at least one SSB, where the second message includes a dynamic indication and may be associated with a first periodicity different than a second periodicity associated with a system information block (SIB) message.

In some examples of the method, UEs, and non-transitory computer-readable medium described herein, performing the monitoring procedure may include operations, features, means, or instructions for performing the monitoring procedure according to the one or more rate matching rules based on the capability of the UE to decode the second message.

In some examples of the method, UEs, and non-transitory computer-readable medium described herein, performing the monitoring procedure according to the one or more rate matching rules may include operations, features, means, or instructions for performing, based on the second message indicating the deactivation of the at least one SSB, rate matching on a portion of the first set of resources associated with the at least one SSB that at least partially overlaps the second set of resources allocated for the downlink transmission.

In some examples of the method, UEs, and non-transitory computer-readable medium described herein, performing the rate matching may include operations, features, means, or instructions for performing the rate matching on the portion of the first set of resources based on a third message scheduling the downlink transmission being a multi-cast transmission.

In some examples of the method, UEs, and non-transitory computer-readable medium described herein, performing the monitoring procedure according to the one or more rate matching rules may include operations, features, means, or instructions for refraining, based on the second message indicating the deactivation of the at least one SSB, from performing rate matching on the portion of the first set of resources associated with the at least one SSB that at least partially overlaps the second set of resources allocated for the downlink transmission.

In some examples of the method, UEs, and non-transitory computer-readable medium described herein, refraining from performing the rate matching may include operations, features, means, or instructions for refraining from performing the rate matching on the portion of the first set of resources based on a third message scheduling the downlink transmission being UE-specific.

In some examples of the method, UEs, and non-transitory computer-readable medium described herein, the downlink transmission includes a SPS-PDSCH.

In some examples of the method, UEs, and non-transitory computer-readable medium described herein, performing the monitoring procedure according to the one or more rate matching rules may include operations, features, means, or instructions for refraining from monitoring an SPS-PDSCH occasion associated with the SPS-PDSCH of a set of multiple SPS-PDSCH occasions based on the second message indicating the deactivation of the at least one SSB.

In some examples of the method, UEs, and non-transitory computer-readable medium described herein, performing the monitoring procedure according to the one or more rate matching rules may include operations, features, means, or instructions for refraining from monitoring a set of multiple SPS-PDSCH occasions based on the second message indicating the deactivation of the at least one SSB, where the SPS-PDSCH may be associated with at least one SPS-PDSCH occasion of the set of multiple SPS-PDSCH occasions.

In some examples of the method, UEs, and non-transitory computer-readable medium described herein, performing the monitoring procedure according to the one or more rate matching rules may include operations, features, means, or instructions for performing, based on the second message indicating the activation of the at least one SSB, rate matching on the portion of the first set of resources associated with the at least one SSB at least partially overlapping the second set of resources allocated for the downlink transmission.

In some examples of the method, UEs, and non-transitory computer-readable medium described herein, performing the monitoring procedure according to the one or more rate matching rules may include operations, features, means, or instructions for refraining from performing rate matching on the portion of the first set of resources associated with the at least one SSB at least partially overlapping the second set of resources allocated for the downlink transmission based on the second message indicating the activation of the at least one SSB and based on a third message scheduling the downlink transmission being a multi-cast transmission.

In some examples of the method, UEs, and non-transitory computer-readable medium described herein, performing the monitoring procedure according to the one or more rate matching rules may include operations, features, means, or instructions for monitoring for the downlink transmission during one or more monitoring occasions based on the second message indicating the deactivation of the at least one SSB, where at least one monitoring occasion of the one or more monitoring occasions may be associated with the second set of resources at least partially overlapping with the first set of resources allocated for the SSB.

In some examples of the method, UEs, and non-transitory computer-readable medium described herein, monitoring for the downlink transmission may include operations, features, means, or instructions for monitoring a UE-specific search space for the downlink transmission.

In some examples of the method, UEs, and non-transitory computer-readable medium described herein, performing the monitoring procedure according to the one or more rate matching rules may include operations, features, means, or instructions for refraining from monitoring for the downlink transmission during one or more monitoring occasions based on the second message indicating the deactivation of the at least one SSB, where at least one monitoring occasion of the one or more monitoring occasions may be associated with the second set of resources at least partially overlapping with the first set of resources allocated for the at least one SSB.

In some examples of the method, UEs, and non-transitory computer-readable medium described herein, the downlink transmission includes a PDSCH, a SPS-PDSCH, or a downlink control information (DCI) message.

In some examples of the method, UEs, and non-transitory computer-readable medium described herein, the second message indicates the one or more rate matching rules.

In some examples of the method, UEs, and non-transitory computer-readable medium described herein, the second message includes a DCI message.

### BRIEF DESCRIPTION OF THE DRAWINGS

FIGS. 1 and 2 show examples of wireless communications systems that support a monitoring procedure for dynamically adapted synchronization signal blocks (SSBs) in accordance with one or more aspects of the present disclosure.

FIG. 3 shows an example of overlapping SSBs and downlink transmissions that supports a monitoring procedure for dynamically adapted SSBs in accordance with one or more aspects of the present disclosure.

FIG. 4 shows an example of a process flow that supports a monitoring procedure for dynamically adapted SSBs in accordance with one or more aspects of the present disclosure.

FIGS. 5 and 6 show block diagrams of devices that support monitoring procedures for dynamically adapted SSBs in accordance with one or more aspects of the present disclosure.

FIG. 7 shows a block diagram of a communications manager that supports a monitoring procedure for dynamically adapted SSBs in accordance with one or more aspects of the present disclosure.

FIG. 8 shows a diagram of a system including a device that supports a monitoring procedure for dynamically adapted SSBs in accordance with one or more aspects of the present disclosure.

FIGS. 9 and 10 show flowcharts illustrating methods that support monitoring procedures for dynamically adapted SSBs in accordance with one or more aspects of the present disclosure.

### DETAILED DESCRIPTION

A wireless communications system may support adaptation of synchronization signal blocks (SSBs). For example, the network entity may adapt SSBs in a time domain (e.g., adapt a periodicity). In some cases, a network entity may activate or deactivate an SSB via a system information block (SIB) indication (e.g., SIB1). For example, the network entity may transmit the SIB on a periodic basis. A user equipment (UE) may receive and decode the SIB (e.g., periodically), where some of the SIBs may activate or deactivate SSBs. However, a periodicity associated with the SIB may not support a threshold level of energy efficiency at the network entity, the UE, or both. For example, the network entity may activate or deactivate SSBs for network energy saving relatively slowly in cases in which the UE waits for and decodes the SIB.

Additionally, or alternatively, the network entity may activate or deactivate (e.g., add or remove) SSBs dynamically. In some examples, dynamic adaptation of SSBs may be associated with a greater level of energy efficiency compared with adaptation of SSBs via SIBs. That is, UEs may receive information associated with SSB adaptation according to whether an SSB is to be activated or deactivated, rather than periodically. However, some UEs (e.g., legacy UEs) may not support the dynamic indication. That is, when a network entity activates or deactivates an SSB via the dynamic indication, a first UE may be unable to read the indication and may wait for the indication via the SIB. The first UE may, in some cases, be one of multiple UEs associated with the network entity (e.g., for a multiple-user (MU)-multiple input multiple output (MIMO) transmission, a multi-cast transmission, etc.). In such cases, the first UE which is unable to read the indication and a second UE which is able to read the indication may have a discrepancy in receipt of downlink signaling overlapping the activated or deactivated SSB. As an example, when the dynamic indication deactivates an SSB, the first UE may perform rate matching around the SSB, despite the SSB not being transmitted, while the second UE may refrain from performing the rate matching based on decoding the dynamic indication. Alternatively, when the dynamic indication activates an SSB, the first UE may not perform rate matching around the SSB, while the second UE may perform the rate matching. That is, some UEs receiving the downlink signaling may perform rate matching, monitoring, or both while others may not. Thus, UEs may be configured to perform monitoring for downlink signaling according to rate matching rules.

As described herein, a UE may perform a monitoring procedure according to the rate matching rules and based on activation or deactivation of SSBs via a dynamic indication. For example, the UE may receive a first message indicating a configuration for multiple SSBs and a second message activating or deactivating at least one SSB of the configuration. In some examples, first resources associated with the activated or deactivated SSB may overlap with second resources associated with a downlink transmission. The UE may receive or monitor for the downlink transmission according to the rate matching rules. For example, the rate matching rules may include whether the UE is to perform rate matching around the overlapping resources, monitor for the downlink transmission, or both. In some examples, the downlink transmission may be a physical downlink shared channel (PDSCH), a semi-persistent scheduling (SPS)-PDSCH, a physical downlink control channel (PDCCH), or the like. Additionally, or alternatively, the downlink transmission may be for a single user (e.g., the UE) or multiple users (e.g., the UE and one or more additional UEs). In some examples, the rate matching rules may indicate a UE behavior associated with the downlink transmission (e.g., whether the UE is to perform rate matching, monitoring, or both) according to whether the downlink transmission is for a single user or multiple users.

Aspects of the disclosure are initially described in the context of wireless communications systems. Aspects of the disclosure are also described in the context of overlapping SSBs and a process flow. Aspects of the disclosure are further illustrated by and described with reference to apparatus diagrams, system diagrams, and flowcharts that relate to monitoring procedure for dynamically adapted SSBs.

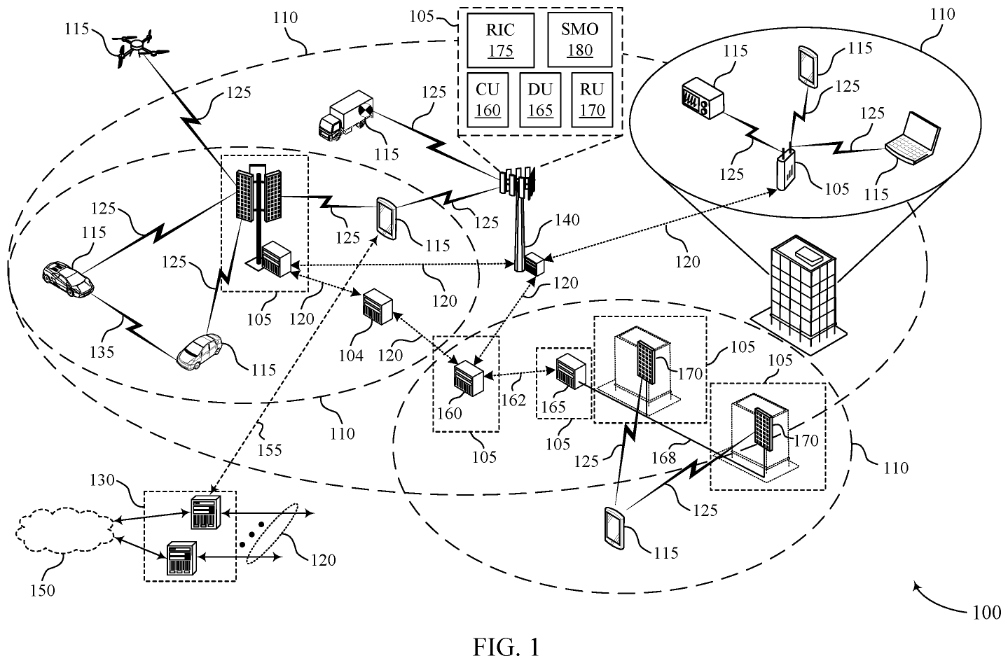

FIG. 1 shows an example of a wireless communications system 100 that supports monitoring procedure for dynamically adapted SSBs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UE 115 may receive (e.g., from a network entity 105) a first message indicating a configuration for multiple SSBs and a second message (e.g., a dynamic indication) indicating an activation or a deactivation of at least one SSB of the configuration. As an example, the second message may activate or deactivate the at least one SSB, which may be associated with a first set of resources at least partially overlapping a second set of resources associated with a downlink transmission. For example, the first set of resources associated with the SSB may overlap with the second set of resources associated with a PDSCH, a PDCCH, or a SPS-PDSCH. The UE 115 may perform a monitoring procedure according to rate matching rules, where the rate matching rules may be based on the activation or deactivation of the SSB, the overlapping resources, or both. For example, the monitoring procedure may include performing rate matching, refraining from performing rate matching, monitoring for a downlink transmission, or refraining from monitoring for a downlink transmission. The rate matching rules may define the monitoring procedure according to whether the UE 115 is receiving a downlink transmission for multiple users or a single user. For example, the UE 115 may perform the monitoring procedure based on aligning a behavior with other UEs 115 receiving the downlink transmission, some of which may not have a capability to decode the second message indicating the activation or deactivation of the SSB.

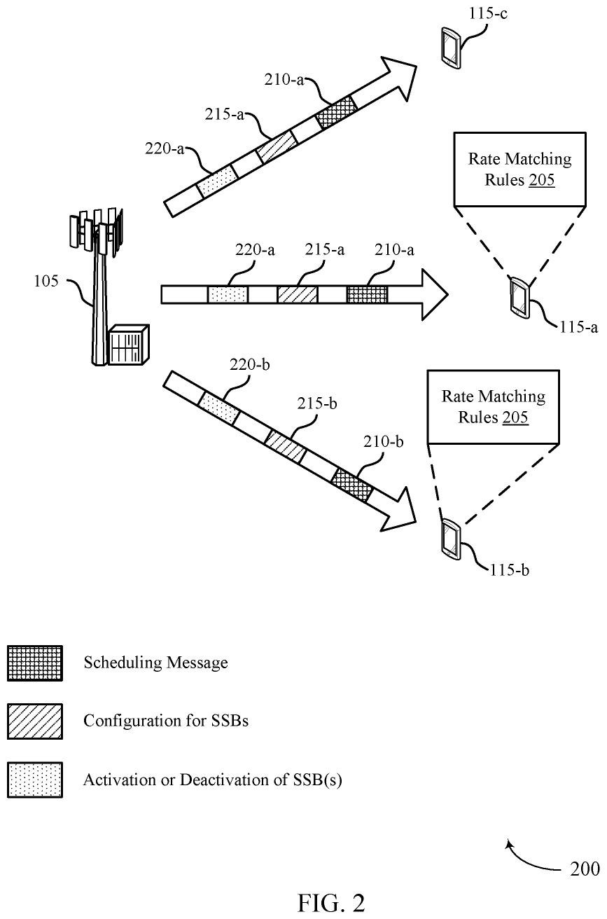

FIG. 2 shows an example of a wireless communications system 200 that supports a monitoring procedure for dynamically adapted SSBs in accordance with one or more aspects of the present disclosure. The wireless communications system 200 may implement or be implemented by various aspects of the wireless communications system 100. For example, the wireless communications system 200 may include a network entity 105, a UE 115-a, a UE 115-b, and a UE 115-c, which may be examples corresponding devices as described with reference to FIG. 1.

In some examples, UEs may be configured with rate matching rules 205. For example, the UE 115-a and the UE 115-b may perform a monitoring procedure in accordance with the rate matching rules 205 and based on the rate matching rules 205 being configured at the UE 115-a and the UE 115-b. The rate matching rules 205 may be pre-configured at (or otherwise defined) or signaled to the UE 115-a, the UE 115-b, or both. For example, the network entity 105 may transmit one or more signals indicating the rate matching rules 205 to the UE 115-a, the UE 115-b, or both. In some examples, the network entity 105 may indicate the rate matching rules 205 to the UE 115-a and the UE 115-b via a message scheduling a downlink transmission.

For example, the network entity 105 may transmit messages to one or more UEs, including the UE 115-a, the UE 115-b, and the UE 115-c to schedule downlink transmissions, configure SSBs, or both. For example, the network entity 105 may transmit a scheduling message 210-a to the UE 115-a and the UE 115-c. The scheduling message 210-a may schedule a first downlink transmission (e.g., a multi-cast or multiple user transmission) to be received by multiple UEs, including the UE 115-a and the UE 115-c. Additionally, or alternatively, the network entity 105 may transmit a scheduling message 210-b to the UE 115-b. The scheduling message 210-b may schedule a second downlink transmission (e.g., a unicast or single user transmission) to be received by a single UE, such as the UE 115-b.

The scheduling message 210-a, the scheduling message 210-b, or both may be examples of downlink control information (DCI) messages. For example, the scheduling message 210-a may be a first type of DCI associated with a downlink message received by multiple UEs (e.g., a multi-cast message). As an example, the scheduling message 210-a may be a DCI scrambled with a group-radio network temporary identifier (G-RNTI). Additionally, or alternatively, the scheduling message 210-b may be a second type of DCI associated with a downlink message received by a single UE (e.g., a unicast message). As an example, the scheduling message 210-b may be a DCI scrambled with a cell-RNTI (C-RNTI).

In some examples, the scheduling message 210-a scheduling the first downlink transmission to be received by the multiple UEs may indicate antenna ports, resources, or both to be used to receive the first downlink transmission. For example, the scheduling message 210-a (e.g., a DCI) may indicate a first set of ports for the UE 115-a and a second set of ports for the UE 115-c. In some examples, the network entity 105 may schedule the UE 115-a and the UE 115-c with shared resources. In other words, downlink resources, such as resources for a PDSCH, may be shared between multiple UEs, such as the UE 115-a and the UE 115-c. In such examples, the UE 115-a, the UE 115-c, or both may determine that the first downlink message is for (e.g., to be received by) at least one other UE based on the scheduling message 210-a. That is, the UE 115-a, the UE 115-c, or both may identify other antenna ports or resources allocated to the at least one other UE and determine that the first downlink message is for multiple UEs.

The scheduling message 210-a, the scheduling message 210-b, or both may schedule a dynamic PDSCH for a single UE (e.g., the UE 115-b), a dynamic PDSCH for multiple users (e.g., the UE 115-a and the UE 115-c), an SPS transmission, or a PDCCH. In other words, the first downlink transmission or the second downlink transmission may be a PDSCH, an SPS transmission (e.g., an SPS-PDSCH), or a PDCCH.

The network entity 105 may transmit a message indicating a configuration for SSBs. For example, the network entity 105 may indicate a configuration for SSBs 215-a to the UE 115-a and the UE 115-c and a configuration for SSBs 215-b to the UE 115-b. The configuration for SSBs 215-a, the configuration for SSBs 215-b, or both may be indicated via an information element (IE) in an RRC message. The UE 115-a, the UE 115-b, the UE 115-c, or any combination thereof may receive the SSBs configured via the configuration for SSBs 215-a or the configuration for SSBs 215-b to perform beam management (e.g., beam-sweeping), measure a coverage level of the network entity 105, measure interference, or the like. For example, the UE 115-a, the UE 115-b, and the UE 115-c may periodically receive (e.g., receive repetitions of an SSB) and measure (e.g., measure a signal strength of) the SSBs and, based on measurements of the SSBs, determine one or more characteristics of a channel. As an example, the UE 115-a, the UE 115-b, and the UE 115-c may determine a beam based on measurements of the SSBs and, in some examples, indicate the beam to the network entity 105.

In some examples, the network entity 105 may activate or deactivate SSBs of the configuration for SSBs 215-a, the configuration for SSBs 215-b, or both. For example, the network entity 105 may transmit a message indicating an activation or deactivation of SSB(s) to one or more of the UE 115-a, the UE 115-b, or the UE 115-c. In the example of FIG. 2, the network entity 105 may transmit an activation or deactivation of SSB(s) 220-a to the UE 115-a and the UE 115-c. Additionally, or alternatively, the network entity 105 may transmit an activation or deactivation of SSB(s) 220-b to the UE 115-b.

The activation or deactivation of SSB(s) 220-a, the activation or deactivation of SSB(s) 220-b, or both may be a dynamic indication. For example, the network entity 105 may activate or deactivate SSBs at a faster rate than, for example, activating or deactivating SSBs via a SIB indication (e.g., SIB1). The dynamic indication may support more efficient network energy saving than the SIB indication, as a latency associated with activating or deactivating SSBs may be lower when the network entity 105 activates or deactivates the SSBs via the dynamic indication (e.g., compared to the SIB indication). For example, the network entity 105 may wait for a next SIB to include an indication to activate or deactivate SSBs (e.g., as SIB1 is transmitted periodically), whereas the network entity 105 may transmit the dynamic indication as the network entity 105 determines to activate or deactivate SSBs.

The UE 115-a and the UE 115-b may decode the dynamic indication based on a capability of the UE 115-a and the UE 115-b, respectively. Alternatively, the UE 115-c may be unable to decode the dynamic indication. That is, the UE 115-c (e.g., a legacy UE) may not have the capability to decode the dynamic indication. In such examples, the UE 115-c may receive, but not be able to decode, the activation or deactivation of SSB(s) 220-a. For example, the UE 115-c may be unaware of the activation or deactivation of SSB(s) 220-a. The UE 115-c may assume SSBs to be transmitted (or not transmitted) according to the configuration for SSB(s) 220-a. Alternatively, the UE 115-a and the UE 115-b may, based on having the capability to decode the dynamic indication, be aware of the activation or deactivation of SSB(s) 220-a and the activation or deactivation of SSB(s) 220-b, respectively.

One or more of the SSB(s) activated or deactivated via the activation or deactivation of SSB(s) 220-a, the activation or deactivation of SSB(s) 220-b, or both, may overlap with a downlink transmission. In other words, a set of resources associated with the one or more SSBs may at least partially overlap (e.g., in time, frequency, or both) with a set of resources associated with the downlink transmission. For example, a first SSB activated or deactivated by the activation or deactivation of SSB(s) 220-a may be associated with a first set of resources at least partially overlapping with a second set of resources associated with the first downlink transmission scheduled by the scheduling message 210-a. Additionally, or alternatively, a second SSB activated or deactivated by the activation or deactivation of SSB(s) 220-b may be associated with a third set of resources at least partially overlapping with a fourth set of resources associated with the second downlink transmission scheduled by the scheduling message 210-b.

The UE 115-a, the UE 115-b, or both may perform monitoring procedures in accordance with the rate matching rules 205. The monitoring procedure may include performing rate matching, refraining from performing rate matching, monitoring, or refraining from monitoring. For example, the UE 115-a and the UE 115-b may determine whether to perform rate matching around an activated or deactivated SSB having a set of resources at least partially overlapping another set of resources associated with the downlink transmission. Additionally, or alternatively, the UE 115-a and the UE 115-b may determine whether to monitor for the downlink transmission having a set of resources at least partially overlapping another set of resources of the activated or deactivated SSB. The monitoring procedure may be based on a type of the downlink transmission, whether the downlink transmission is for multiple users, or both. In other words, the rate matching rules 205 may define monitoring procedures (i.e., including whether to perform rate matching, monitoring, or both) associated with types of downlink transmissions.

As an example, the UE 115-a may, according to the rate matching rules 205, refrain from performing rate matching around an activated or a deactivated SSB based on the activated or deactivated SSB having the first set of resources at least partially overlapping the second set of resources associated with the first downlink transmission, where the first downlink transmission is to be received by the UE 115-a and the UE 115-c. In other words, the UE 115-a may refrain from performing rate matching based on an activated or deactivated SSB overlapping a downlink transmission for multiple users. For example, the UE 115-a may refrain from performing the rate matching in accordance with one or more users of the multiple users not having a capability to decode the dynamic indication (e.g., the activation or deactivation of SSB(s) 220-a). As an example, the UE 115-c may not perform rate matching around an activated or deactivated SSB. For example, because the UE 115-c may not have the capability to decode the dynamic indication (e.g., the activation or deactivation of SSB(s) 220-a), the UE 115-c may be unaware that the SSB is activated or deactivated.

Alternatively, the UE 115-b may perform the rate matching around an activated or a deactivated SSB based on the deactivated SSB having the third set of resources at least partially overlapping the fourth set of resources associated with the second downlink transmission, where the second downlink transmission is to be received by the UE 115-b (e.g., only the UE 115-b). In other words, the UE 115-b may perform the rate matching based on the activated or deactivated SSB overlapping a downlink transmission for a single user.

Rate matching may refer to a UE, such as the UE 115-a, the UE 115-b, or the UE 115-c, puncturing, repeating, or shortening encoded bits to fit available resources around an activated or deactivated SSB. If a quantity of encoded bits is more than the available resources, some of the bits may be punctured (e.g., discarded) to fit the available resources. If the quantity of encoded bits is less than the available resources, the bits may be repeated to fill gaps in the available resources. In the example of an SSB overlapping a downlink transmission, the UE may puncture, repeat, or shorten the encoded bits of the downlink transmission, the SSB, or both to fit a set of resources allocated for the SSB and a set of resources allocated for the downlink transmission.

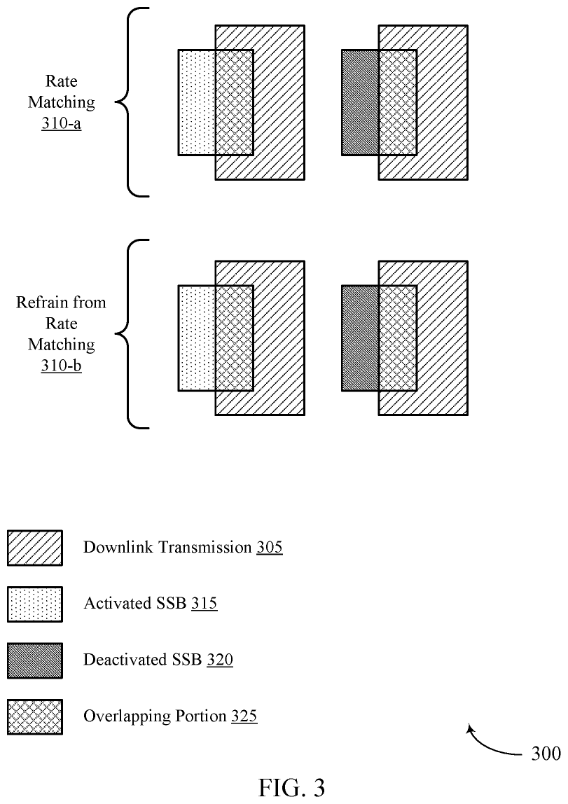

FIG. 3 shows an example of overlapping SSBs and downlink transmissions 300 that support monitoring procedures for dynamically adapted SSBs in accordance with one or more aspects of the present disclosure. The overlapping SSBs and downlink transmissions 300 may implement or be implemented by various aspects of the wireless communications system 100, the wireless communications system 200, or both. For example, the overlapping SSBs and downlink transmissions 300 may include a downlink transmission 305, which may be an example of the downlink transmission scheduled by the scheduling message 210-a, the scheduling message 210-b, or both as described with reference to FIG. 2. Additionally, the overlapping SSBs and downlink transmissions 300 may include an activated SSB 315 and a deactivated SSB 320, which may be examples of SSBs activated or deactivated by a dynamic indication, such as the activation or deactivation of SSB(s) 220-a or the activation or deactivation of SSB(s) 220-b as described with reference to FIG. 2.

In some examples, UEs may be configured with rate matching rules, such as the rate matching rules 205 as described with reference to FIG. 2. For example, a UE may perform a monitoring procedure in accordance with the rate matching rules. The monitoring procedure may include performing rate matching, refraining from performing rate matching, monitoring, or refraining from monitoring or decoding. For example, the UE may determine whether to perform rate matching around an activated or deactivated SSB having a set of resources at least partially overlapping another set of resources associated with a downlink transmission (e.g., based on the rate matching rules). Additionally, or alternatively, the UE may determine whether to monitor for the downlink transmission having a set of resources at least partially overlapping another set of resources of the activated or deactivated SSB (e.g., based on the rate matching rules). The monitoring procedure may be based on a type of the downlink transmission, whether the downlink transmission is for multiple users, or both. In other words, the rate matching rules may define monitoring procedures (i.e., including whether to perform rate matching, monitoring, or both) associated with types of downlink transmissions.

In some examples, the UE may perform rate matching 310-a around a first set of resources associated with an SSB and a second set of resources associated with the downlink transmission 305. For example, the UE may perform the rate matching 310-a on or around an overlapping portion 325 associated with the downlink transmission 305 and the activated SSB 315 or the deactivated SSB 320. Alternatively, the UE may refrain from rate matching 310-b around the first set of resources associated with the SSB and the second set of resources associated with the downlink transmission 305. For example, the UE may refrain from rate matching 310-a on or around an overlapping portion 325 associated with the downlink transmission 305 and the activated SSB 315 or the deactivated SSB 320.

The downlink transmission 305 may be an example of a PDSCH. When the UE receives a dynamic indication deactivating an SSB (e.g., in a time domain), and when the UE is scheduled to receive the PDSCH that overlaps (e.g., at least partially) with the SSB that is deactivated, the UE may perform rate matching 310-a, refrain from rate matching 310-b, or determine whether to perform rate matching 310-a based on a type of control message (e.g., DCI) scheduling the PDSCH. For example, the UE may determine to perform rate matching based on the PDSCH being scheduled with a DCI scrambled with G-RNTI (e.g., scheduling a multi-cast transmission). Alternatively, the UE may determine to refrain from rate matching 310-b based on the PDSCH being scheduled with C-RNTI or UE-specific DCI.

In another example, the UE may receive a dynamic indication activating an SSB (e.g., in the time domain), and the UE may perform rate matching 310-a or refrain from rate matching 310-b. For example, the UE may perform the rate matching 310-a for a dynamically scheduled PDSCH around the activated SSB 315 (e.g., on or around an overlapping portion 325). Alternatively, the UE may refrain from rate matching 310-b based on the PDSCH being transmitted to multiple users. That is, the UE may refrain from rate matching 310-b based on another UE of a group of UEs to receive the PDSCH not having a capability to decode dynamic indications. In such examples, the UE may perform a decoding attempt for the activated SSB 315, the PDSCH, or both (e.g., despite refraining from performing rate matching). In some other examples, the UE may be configured to perform the rate matching 310-a or refrain from performing rate matching 310-b based on the UE being scheduled with a multi-cast or broadcast DCI or based on the UE being indicated a multiple user transmission involving multiple UEs.

In some examples, the downlink transmission 305 may be an example of an SPS-PDSCH. The UE may receive a dynamic indication deactivating an SSB that overlaps (e.g., at least partially) with SPS-PDSCH occasion and perform the rate matching 310-a or refrain from performing rate matching 310-b. Additionally, or alternatively, the UE may monitor for the SPS-PDSCH or refrain from monitoring for the SPS-PDSCH. For example, the UE may refrain from monitoring for the SPS- PDSCH occasion (e.g., a single occasion) based on determining that the SPS-PDSCH occasion is dropped (e.g., by a network entity). Additionally, or alternatively, the UE may refrain from monitoring for the SPS-PDSCH (e.g., the entire SPS-PDSCH) based on determining that the SPS-PDSCH is dropped (e.g., the SPS-PDSCH is deactivated). In other words, the UE may not monitor for the SPS-PDSCH occasion having resources overlapping with the deactivated SSB 320 as well as SPS-PDSCH occasions occurring after the SPS-PDSCH occasion in time. Alternatively, the UE may monitor for the SPS-PDSCH. For example, the UE may monitor for the SPS-PDSCH and either perform rate matching 310-a or refrain from rate matching 310-b based on determining that the SPS-PDSCH is to be transmitted (e.g., by a network entity).

In some examples, the UE may determine whether an SPS-PDSCH is dropped according to a rate matching rule, such as the rate matching rules 205 as described with reference to FIG. 2. For example, the UE may determine that a network entity may deactivate an SSB to support energy saving. The UE may determine that the SPS-PDSCH occasion overlapping with the deactivated SSB 320 may also be dropped such that the network may enter a sleep state and save energy.

In some other examples, the downlink transmission 305 may be a PDCCH. In such examples, the UE may receive a dynamic indication deactivating an SSB that overlaps (e.g., at least partially) with the PDCCH, and the UE may monitor or refrain from monitoring for the PDCCH. For example, the UE may monitor for the PDCCH (e.g., a DCI) in one or more monitoring occasions at least partially overlapping with resources of the deactivated SSB 320. Alternatively, the UE may refrain from monitoring for the PDCCH (e.g., a DCI) in the one or more monitoring occasions at least partially overlapping with the resources of the deactivated SSB 320. Or, the UE may monitor a UE-specific search space but refrain from monitoring a group common search space. For example, the UE may monitor for a PDCCH overlapping with the deactivated SSB 320 in the UE-specific search space and refrain from monitoring for a PDCCH overlapping with the deactivated SSB 320 in the group common search space.

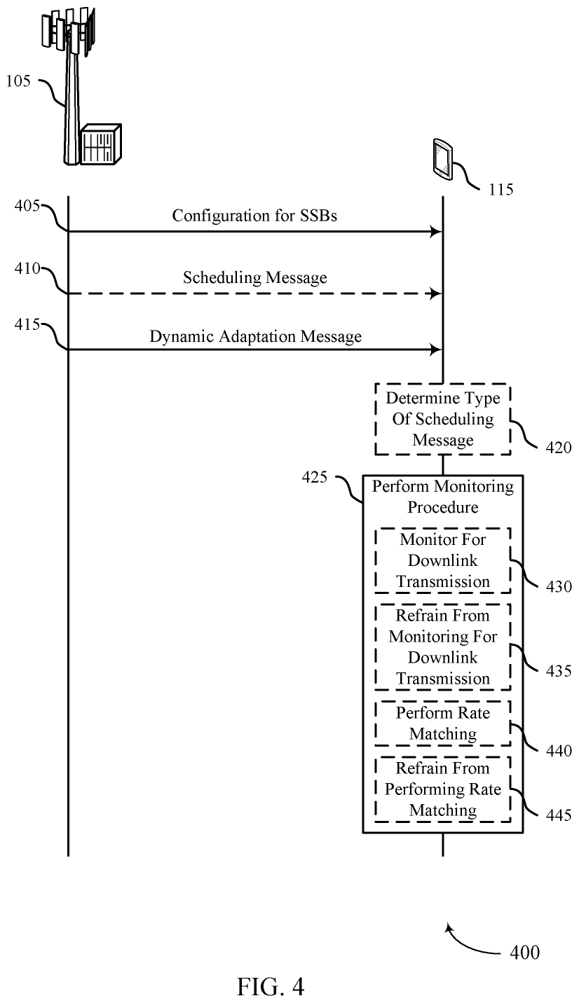

FIG. 4 shows an example of a process flow 400 that supports a monitoring procedure for dynamically adapted SSBs in accordance with one or more aspects of the present disclosure. In some examples, the process flow 400 may implement or be implemented by aspects of the wireless communications system 100 or the wireless communications system 200 as described with reference to FIG. 1 or FIG. 2. For example, the process flow 400 may be implemented by a network entity 105 and a UE 115, which may be examples of the network entity 105 and the UEs 115, respectively, as described with reference to FIG. 1 and FIG. 2. The process flow 400 may also implement or be implemented by aspects of the overlapping SSBs and downlink transmissions 300. Alternative examples of the following may be implemented, where some steps are performed in a different order than described or are not performed at all. In some cases, steps may include additional features not mentioned below, or further steps may be added.

At 405, the network entity 105 may transmit a configuration for SSBs to the UE 115. For example, the UE 115 may receive a first message from the network entity 105 indicating a configuration for a set of multiple SSBs, where the configuration may indicate sets of resources for each SSB of the set of multiple SSBs. As an example, the configuration may indicate a first set of resources associated with an SSB of the set of multiple SSBs. The first message indicating the configuration for the set of multiple SSBs may be an example of the configuration for SSBs 215-a, the configuration for SSBs 215-b, or both as described with reference to FIG. 2.

At 410, the network entity 105 may transmit a scheduling message to the UE 115. In other words, the network entity 105 may transmit the scheduling message scheduling a downlink transmission. For example, the scheduling message may be an example of the scheduling message 210-a, the scheduling message 210-b, or both as described with reference to FIG. 2. The downlink transmission may be a PDSCH, an SPS-PDSCH, or a DCI message (e.g., a PDCCH). For example, the downlink transmission may be an example of the downlink transmission 305 as described with reference to FIG. 3.

At 415, the network entity 105 may transmit a dynamic adaptation message to the UE 115. For example, the UE 115 may receive a second message indicating an activation or a deactivation of at least one SSB of the set of multiple SSBs of the configuration received at 405. The second message indicating the activation or the deactivation of the at least one SSB may be an example of the activation or deactivation of SSB(s) 220-a, the activation or deactivation of SSB(s) 220-b, or both as described with reference to FIG. 2. The at least one SSB may include the SSB associated with the first set of resources, where the first set of resources may at least partially overlap with the second set of resources allocated for the downlink transmission. For example, the first set of resources may at least partially overlap with the second set of resources in a portion, such as the overlapping portion 325 as described with reference to FIG. 3.

In some examples, the second message indicating the activation or the deactivation of the at least one SSB may be a dynamic indication. The dynamic indication (e.g., a DCI) may be associated with a first periodicity different than a second periodicity associated with a SIB message. Additionally, or alternatively, the dynamic indication may be more efficient (e.g., for network energy saving) than the SIB message.

Additionally, or alternatively, the second message may indicate one or more rate matching rules. That is, the second message adapting the at least one SSB may also indicate an associated behavior for a monitoring procedure, such as monitoring for the downlink transmission, refraining from monitoring for the downlink transmission, performing rate matching, or refraining from performing rate matching.

At 420, the UE 115 may determine a type of scheduling message. For example, the UE 115 may identify whether the scheduling message, the downlink transmission, or both are associated with a single user or multiple users. As an example, the UE 115 may determine the type of scheduling message based on a DCI of the scheduling message, such as based on the DCI being scrambled with a G-RNTI or a C-RNTI. As another example, the UE 115 may determine the type of scheduling message based on the second set of resources allocated for the downlink transmission. For example, the UE 115 may identify whether the resources are shared between the UE 115 and one or more other UEs.

At 425, the UE 115 may perform a monitoring procedure. For example, the UE 115 may perform the monitoring procedure according to one or more rate matching rules, such as the rate matching rules 205 as described with reference to FIG. 2. The one or more rate matching rules may be based on the activation or deactivation or the at least one SSB at 415. Additionally, or alternatively, the one or more rate matching rules may be based on the first set of resources at least partially overlapping with the second set of resources allocated for the downlink transmission.

In some examples, the UE 115 may perform the monitoring procedure based on having a capability to decode the second message indicating the activation or the deactivation of the at least one SSB.

At 430, the UE 115 may monitor for the downlink transmission. For example, the UE 115 may monitor for the downlink transmission during one or more monitoring occasions based on the second message indicating the deactivation of the at least one SSB. In some examples, at least one monitoring occasion of the one or more monitoring occasions may be associated with the second set of resources at least partially overlapping with the first set of resources allocated for the SSB. In other words, the UE 115 may monitor for DCI in monitoring occasions overlapping with resources of the removed SSB. Additionally, or alternatively, the UE 115 may monitor for the downlink transmission in a UE-specific search space.

In some examples, monitoring for the downlink transmission may further include performing rate matching or performing rate matching. For example, the UE 115 may determine, according to the one or more rate matching rules, whether to perform the rate matching after monitoring for the downlink transmission. In other words, the UE 115 may perform the rate matching at 440 or refrain from performing the rate matching at 445 after monitoring for the downlink transmission at 430.

At 435, the UE 115 may refrain from monitoring for the downlink transmission. For example, the UE 115 may refrain from monitoring an SPS-PDSCH occasion associated with the downlink transmission, which may be an example of an SPS-PDSCH, based on the second message indicating the deactivation of the at least one SSB. In other words, the UE 115 may determine (e.g., assume) that the SPS-PDSCH occasion is dropped with the dropped SSB. Additionally, or alternatively, the UE 115 may refrain from monitoring multiple SPS-PDSCH occasions (e.g., all SPS-PDSCH occasions) associated with the SPS-PDSCH based on the second message indicating the deactivation of the at least one SSB. In other words, the UE 115 my determine (e.g., assume) that the SPS-PDSCH (e.g., entirely) is dropped with the dropped SSB.

In some examples, the UE 115 may refrain from monitoring for the downlink transmission during one or more monitoring occasions based on the second message indicating the deactivation of the at least one SSB. For example, at least one monitoring occasion of the one or more monitoring occasions may be associated with the second set of resources at least partially overlapping with the first set of resources allocated for the at least one SSB. In some examples, the UE 115 may refrain from monitoring for the downlink transmission in a group common search space.

At 440, the UE 115 may perform rate matching. For example, the UE 115 may perform the rate matching, which may be an example of the rate matching 310-a as described with reference to FIG. 3, around resources of an activated SSB or a deactivated SSB, such as the activated SSB 315 or the deactivated SSB 320 as described with reference to FIG. 3. Rate matching may include the UE 115 puncturing, repeating or shortening encoded bits to fit available resources around the activated or the deactivated SSB. For example, the UE 115 may puncture one or more bits based on a quantity of encoded bits exceeding available resources. Or, the UE 115 may repeat one or more bits based on the quantity of encoded bits being less than the available resources. The UE 115 may perform the rate matching at 440 in accordance with the one or more rate matching rules.

For example, the UE 115 may perform, based on the second message indicating the deactivation of the at least one SSB, rate matching on a portion of the first set of resources associated with the at least one SSB that at least partially overlaps the second set of resources allocated for the downlink transmission. In other words, the UE 115 may determine (e.g., assume) rate matching around the resources of a dropped SSB. The UE 115 may perform the rate matching on the portion of the first set of resources based on the scheduling message scheduling the downlink transmission being a multi-cast transmission. For example, the UE 115 may refrain from performing the rate matching based on determining, at 420, that the type of scheduling message is for multiple users.

Additionally, or alternatively, the UE 115 may perform, based on the second message indicating the activation of the at least one SSB, rate matching on the portion of the first set of resources associated with the at least one SSB at least partially overlapping the second set of resources allocated for the downlink transmission. In other words, the UE 115 may determine (e.g., assume) rate matching around the resources of an added (e.g., dynamically added) SSB.

At 445, the UE 115 may refrain from performing rate matching. For example, the UE 115 may refrain from performing the rate matching, which may be an example of refrain from rate matching 310-b as described with reference to FIG. 3, around resources of an activated SSB or a deactivated SSB, such as the activated SSB 315 or the deactivated SSB 320 as described with reference to FIG. 3. The UE 115 may refrain from performing the rate matching at 445 in accordance with the one or more rate matching rules.

For example, the UE 115 may refrain, based on the second message indicating the deactivation of the at least one SSB, from performing rate matching on the portion of the first set of resources associated with the at least one SSB that at least partially overlaps the second set of resources allocated for the downlink transmission. In other words, the UE 115 may determine (e.g., assume) no rate matching around the resources of the dropped SSB. The UE 115 may refrain from performing the rate matching on the portion of the first set of resources based on the scheduling message scheduling the downlink transmission being UE-specific. For example, the UE 115 may refrain from performing the rate matching based on determining, at 420, that the type of scheduling message is associated with a single UE.

Additionally, or alternatively, the UE 115 may refrain from performing rate matching on the portion of the first set of resources associated with the at least one SSB at least partially overlapping the second set of resources allocated for the downlink transmission based on the second message indicating the activation of the at least one SSB and based on the scheduling message scheduling the downlink transmission being a multi-cast transmission. For example, the UE 115 may refrain from performing the rate matching based on determining, at 420, that the type of scheduling message is associated with multiple users.

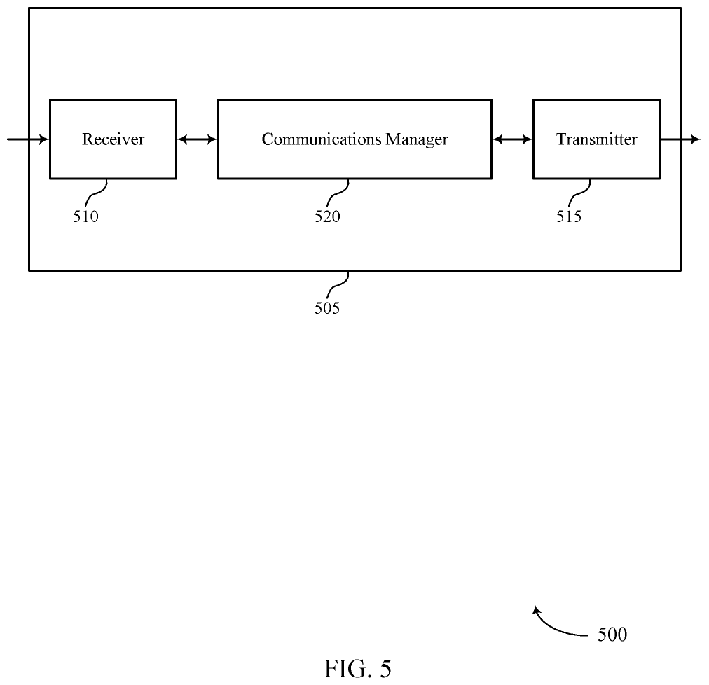

FIG. 5 shows a block diagram 500 of a device 505 that supports monitoring procedures for dynamically adapted SSBs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to monitoring procedure for dynamically adapted SSBs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to monitoring procedure for dynamically adapted SSBs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of monitoring procedure for dynamically adapted SSBs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a first message indicating a configuration for a set of multiple SSBs. The communications manager 520 is capable of, configured to, or operable to support a means for receiving a second message indicating an activation or a deactivation of at least one SSB of the set of multiple SSBs of the configuration, where the at least one SSB is associated with a first set of resources at least partially overlapping with a second set of resources allocated for a downlink transmission. The communications manager 520 is capable of, configured to, or operable to support a means for performing a monitoring procedure according to one or more rate matching rules, where the one or more rate matching rules are based on the activation or the deactivation of the at least one SSB and based on the first set of resources at least partially overlapping with the second set of resources allocated for the downlink transmission.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

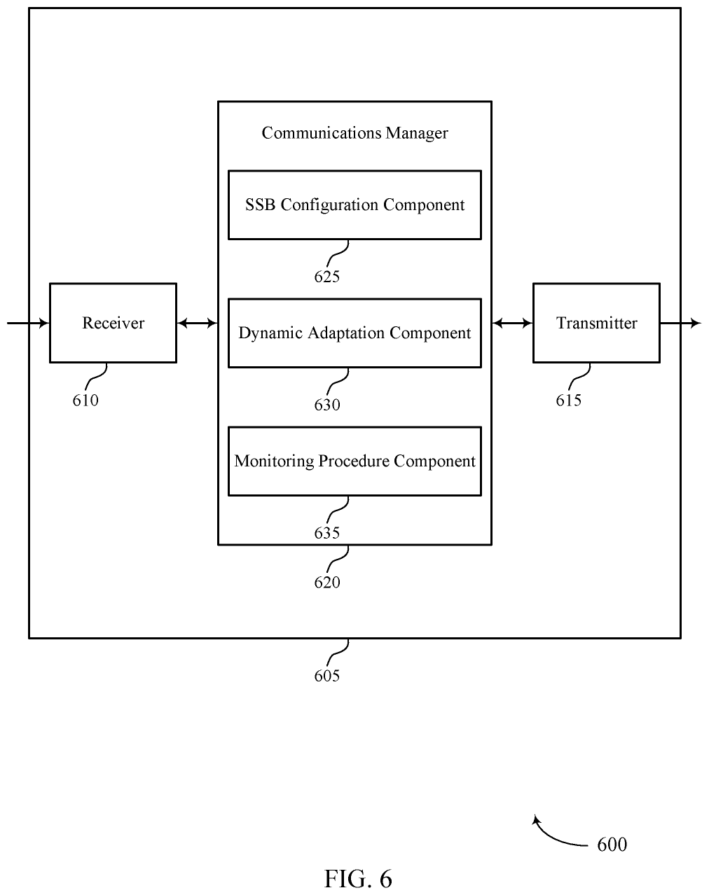

FIG. 6 shows a block diagram 600 of a device 605 that supports monitoring procedure for dynamically adapted SSBs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to monitoring procedure for dynamically adapted SSBs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to monitoring procedure for dynamically adapted SSBs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of monitoring procedure for dynamically adapted SSBs as described herein. For example, the communications manager 620 may include an SSB configuration component 625, a dynamic adaptation component 630, a monitoring procedure component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SSB configuration component 625 is capable of, configured to, or operable to support a means for receiving a first message indicating a configuration for a set of multiple SSBs. The dynamic adaptation component 630 is capable of, configured to, or operable to support a means for receiving a second message indicating an activation or a deactivation of at least one SSB of the set of multiple SSBs of the configuration, where the at least one SSB is associated with a first set of resources at least partially overlapping with a second set of resources allocated for a downlink transmission. The monitoring procedure component 635 is capable of, configured to, or operable to support a means for performing a monitoring procedure according to one or more rate matching rules, where the one or more rate matching rules are based on the activation or the deactivation of the at least one SSB and based on the first set of resources at least partially overlapping with the second set of resources allocated for the downlink transmission.

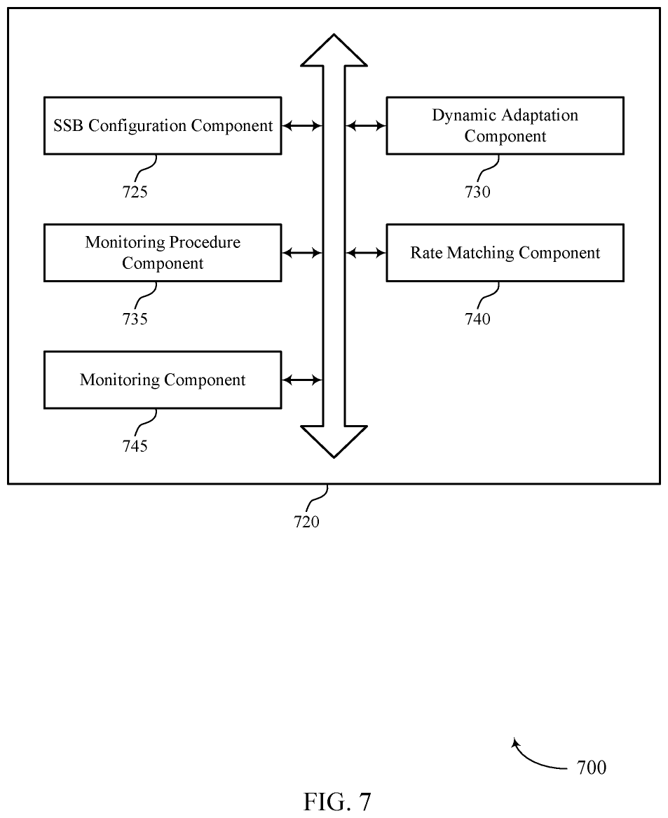

FIG. 7 shows a block diagram 700 of a communications manager 720 that supports monitoring procedures for dynamically adapted SSBs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of monitoring procedure for dynamically adapted SSBs as described herein. For example, the communications manager 720 may include an SSB configuration component 725, a dynamic adaptation component 730, a monitoring procedure component 735, a rate matching component 740, a monitoring component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SSB configuration component 725 is capable of, configured to, or operable to support a means for receiving a first message indicating a configuration for a set of multiple SSBs. The dynamic adaptation component 730 is capable of, configured to, or operable to support a means for receiving a second message indicating an activation or a deactivation of at least one SSB of the set of multiple SSBs of the configuration, where the at least one SSB is associated with a first set of resources at least partially overlapping with a second set of resources allocated for a downlink transmission. The monitoring procedure component 735 is capable of, configured to, or operable to support a means for performing a monitoring procedure according to one or more rate matching rules, where the one or more rate matching rules are based on the activation or the deactivation of the at least one SSB and based on the first set of resources at least partially overlapping with the second set of resources allocated for the downlink transmission.

In some examples, to support receiving the second message, the dynamic adaptation component 730 is capable of, configured to, or operable to support a means for receiving the second message indicating the activation or the deactivation of the at least one SSB, where the second message includes a dynamic indication and is associated with a first periodicity different than a second periodicity associated with an SIB message.

In some examples, to support performing the monitoring procedure, the monitoring procedure component 735 is capable of, configured to, or operable to support a means for performing the monitoring procedure according to the one or more rate matching rules based on the capability of the UE to decode the second message.

In some examples, to support performing the monitoring procedure according to the one or more rate matching rules, the rate matching component 740 is capable of, configured to, or operable to support a means for performing, based on the second message indicating the deactivation of the at least one SSB, rate matching on a portion of the first set of resources associated with the at least one SSB that at least partially overlaps the second set of resources allocated for the downlink transmission.

In some examples, to support performing the rate matching, the rate matching component 740 is capable of, configured to, or operable to support a means for performing the rate matching on the portion of the first set of resources based on a third message scheduling the downlink transmission being a multi-cast transmission.

In some examples, to support performing the monitoring procedure according to the one or more rate matching rules, the rate matching component 740 is capable of, configured to, or operable to support a means for refraining, based on the second message indicating the deactivation of the at least one SSB, from performing rate matching on the portion of the first set of resources associated with the at least one SSB that at least partially overlaps the second set of resources allocated for the downlink transmission.

In some examples, to support refraining from performing the rate matching, the rate matching component 740 is capable of, configured to, or operable to support a means for refraining from performing the rate matching on the portion of the first set of resources based on a third message scheduling the downlink transmission being UE-specific.

In some examples, the downlink transmission includes an SPS-PDSCH.

In some examples, to support performing the monitoring procedure according to the one or more rate matching rules, the monitoring component 745 is capable of, configured to, or operable to support a means for refraining from monitoring an SPS-PDSCH occasion associated with the SPS-PDSCH of a set of multiple SPS-PDSCH occasions based on the second message indicating the deactivation of the at least one SSB.

In some examples, to support performing the monitoring procedure according to the one or more rate matching rules, the monitoring component 745 is capable of, configured to, or operable to support a means for refraining from monitoring a set of multiple SPS-PDSCH occasions based on the second message indicating the deactivation of the at least one SSB, where the SPS-PDSCH is associated with at least one SPS-PDSCH occasion of the set of multiple SPS-PDSCH occasions.

In some examples, to support performing the monitoring procedure according to the one or more rate matching rules, the rate matching component 740 is capable of, configured to, or operable to support a means for performing, based on the second message indicating the activation of the at least one SSB, rate matching on the portion of the first set of resources associated with the at least one SSB at least partially overlapping the second set of resources allocated for the downlink transmission.

In some examples, to support performing the monitoring procedure according to the one or more rate matching rules, the rate matching component 740 is capable of, configured to, or operable to support a means for refraining from performing rate matching on the portion of the first set of resources associated with the at least one SSB at least partially overlapping the second set of resources allocated for the downlink transmission based on the second message indicating the activation of the at least one SSB and based on a third message scheduling the downlink transmission being a multi-cast transmission.

In some examples, to support performing the monitoring procedure according to the one or more rate matching rules, the monitoring component 745 is capable of, configured to, or operable to support a means for monitoring for the downlink transmission during one or more monitoring occasions based on the second message indicating the deactivation of the at least one SSB, where at least one monitoring occasion of the one or more monitoring occasions is associated with the second set of resources at least partially overlapping with the first set of resources allocated for the SSB.

In some examples, to support monitoring for the downlink transmission, the monitoring component 745 is capable of, configured to, or operable to support a means for monitoring a UE-specific search space for the downlink transmission.

In some examples, to support performing the monitoring procedure according to the one or more rate matching rules, the monitoring component 745 is capable of, configured to, or operable to support a means for refraining from monitoring for the downlink transmission during one or more monitoring occasions based on the second message indicating the deactivation of the at least one SSB, where at least one monitoring occasion of the one or more monitoring occasions is associated with the second set of resources at least partially overlapping with the first set of resources allocated for the at least one SSB.

In some examples, the downlink transmission includes an PDSCH, an SPS-PDSCH, or a DCI message.

In some examples, the second message indicates the one or more rate matching rules.

In some examples, the second message includes a DCI message.

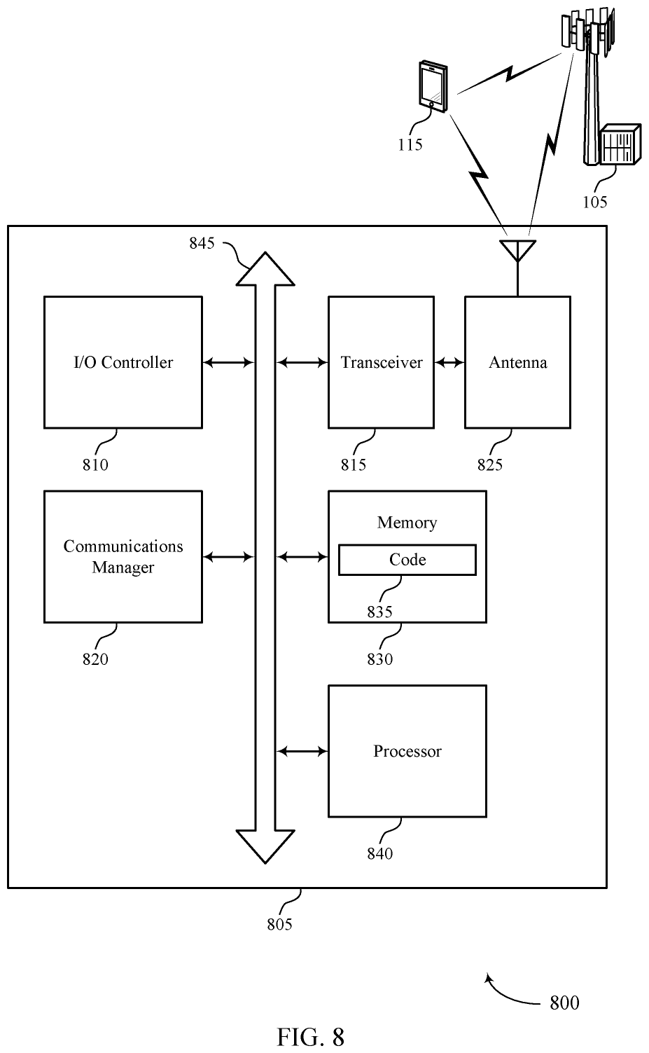

FIG. 8 shows a diagram of a system 800 including a device 805 that supports monitoring procedures for dynamically adapted SSBs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting monitoring procedure for dynamically adapted SSBs). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a first message indicating a configuration for a set of multiple SSBs. The communications manager 820 is capable of, configured to, or operable to support a means for receiving a second message indicating an activation or a deactivation of at least one SSB of the set of multiple SSBs of the configuration, where the at least one SSB is associated with a first set of resources at least partially overlapping with a second set of resources allocated for a downlink transmission. The communications manager 820 is capable of, configured to, or operable to support a means for performing a monitoring procedure according to one or more rate matching rules, where the one or more rate matching rules are based on the activation or the deactivation of the at least one SSB and based on the first set of resources at least partially overlapping with the second set of resources allocated for the downlink transmission.

By including or configuring the communications manager 820 in accordance with examples as described herein, the device 805 may support techniques for reduced latency, reduced power consumption, improved coordination between devices, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of monitoring procedure for dynamically adapted SSBs as described herein, or the at least one processor 840 and the at least one memory 830 may be otherwise configured to, individually or collectively, perform or support such operations.

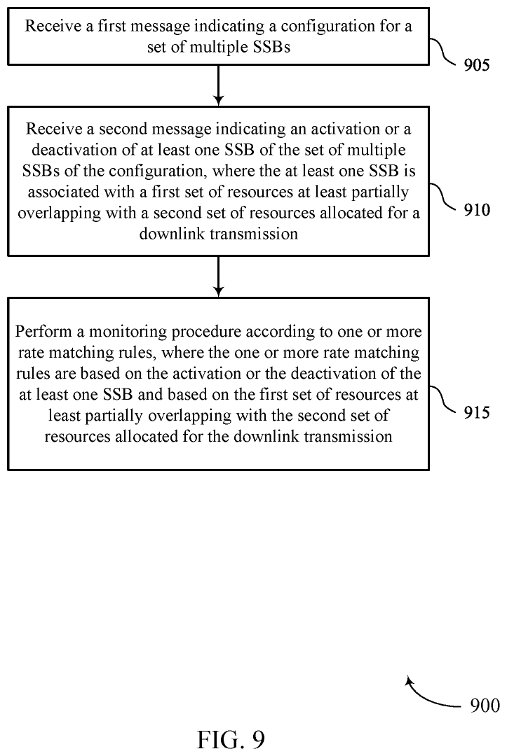

FIG. 9 shows a flowchart illustrating a method 900 that supports monitoring procedures for dynamically adapted SSBs in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a first message indicating a configuration for a set of multiple SSBs. The operations of 905 may be performed in accordance with examples as disclosed herein. In some examples, aspects of the operations of 905 may be performed by an SSB configuration component 725 as described with reference to FIG. 7.

At 910, the method may include receiving a second message indicating an activation or a deactivation of at least one SSB of the set of multiple SSBs of the configuration, where the at least one SSB is associated with a first set of resources at least partially overlapping with a second set of resources allocated for a downlink transmission. The operations of 910 may be performed in accordance with examples as disclosed herein. In some examples, aspects of the operations of 910 may be performed by a dynamic adaptation component 730 as described with reference to FIG. 7.

At 915, the method may include performing a monitoring procedure according to one or more rate matching rules, where the one or more rate matching rules are based on the activation or the deactivation of the at least one SSB and based on the first set of resources at least partially overlapping with the second set of resources allocated for the downlink transmission. The operations of 915 may be performed in accordance with examples as disclosed herein. In some examples, aspects of the operations of 915 may be performed by a monitoring procedure component 735 as described with reference to FIG. 7.

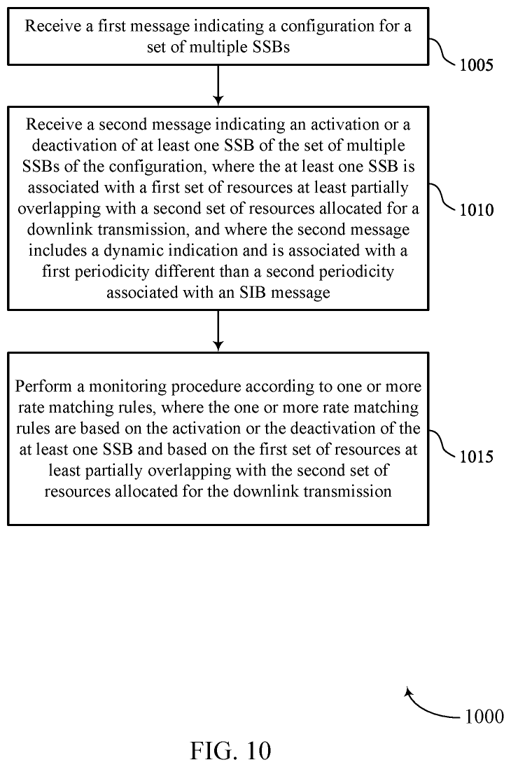

FIG. 10 shows a flowchart illustrating a method 1000 that supports monitoring procedure for dynamically adapted SSBs in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving a first message indicating a configuration for a set of multiple SSBs. The operations of 1005 may be performed in accordance with examples as disclosed herein. In some examples, aspects of the operations of 1005 may be performed by an SSB configuration component 725 as described with reference to FIG. 7.

At 1010, the method may include receiving a second message indicating an activation or a deactivation of at least one SSB of the set of multiple SSBs of the configuration, where the at least one SSB is associated with a first set of resources at least partially overlapping with a second set of resources allocated for a downlink transmission, and where the second message includes a dynamic indication and is associated with a first periodicity different than a second periodicity associated with an SIB message. The operations of 1010 may be performed in accordance with examples as disclosed herein. In some examples, aspects of the operations of 1010 may be performed by a dynamic adaptation component 730 as described with reference to FIG. 7.

At 1015, the method may include performing a monitoring procedure according to one or more rate matching rules, where the one or more rate matching rules are based on the activation or the deactivation of the at least one SSB and based on the first set of resources at least partially overlapping with the second set of resources allocated for the downlink transmission. The operations of 1015 may be performed in accordance with examples as disclosed herein. In some examples, aspects of the operations of 1015 may be performed by a monitoring procedure component 735 as described with reference to FIG. 7.

The following provides an overview of aspects of the present disclosure:

Aspect 1: A method for wireless communications at a UE, comprising: receiving a first message indicating a configuration for a plurality of SSBs; receiving a second message indicating an activation or a deactivation of at least one SSB of the plurality of SSBs of the configuration, wherein the at least one SSB is associated with a first set of resources at least partially overlapping with a second set of resources allocated for a downlink transmission; and performing a monitoring procedure according to one or more rate matching rules, wherein the one or more rate matching rules are based at least in part on the activation or the deactivation of the at least one SSB and based at least in part on the first set of resources at least partially overlapping with the second set of resources allocated for the downlink transmission.

Aspect 2: The method of aspect 1, wherein receiving the second message comprises: receiving the second message indicating the activation or the deactivation of the at least one SSB, wherein the second message comprises a dynamic indication and is associated with a first periodicity different than a second periodicity associated with an SIB message.

Aspect 3: The method of any of aspects 1 through 2, wherein the UE has a capability to decode the second message indicating the activation or the deactivation of the at least one SSB, and wherein performing the monitoring procedure comprises: performing the monitoring procedure according to the one or more rate matching rules based at least in part on the capability of the UE to decode the second message.

Aspect 4: The method of any of aspects 1 through 3, wherein performing the monitoring procedure according to the one or more rate matching rules comprises: performing, based at least in part on the second message indicating the deactivation of the at least one SSB, rate matching on a portion of the first set of resources associated with the at least one SSB that at least partially overlaps the second set of resources allocated for the downlink transmission.

Aspect 5: The method of aspect 4, wherein performing the rate matching further comprises: performing the rate matching on the portion of the first set of resources based at least in part on a third message scheduling the downlink transmission being a multi-cast transmission.

Aspect 6: The method of any of aspects 1 through 5, wherein performing the monitoring procedure according to the one or more rate matching rules comprises: refraining, based at least in part on the second message indicating the deactivation of the at least one SSB, from performing rate matching on the portion of the first set of resources associated with the at least one SSB that at least partially overlaps the second set of resources allocated for the downlink transmission.

Aspect 7: The method of aspect 6, wherein refraining from performing the rate matching further comprises: refraining from performing the rate matching on the portion of the first set of resources based at least in part on a third message scheduling the downlink transmission being UE-specific.

Aspect 8: The method of any of aspects 1 through 7, wherein the downlink transmission comprises a SPS-PDSCH.

Aspect 9: The method of aspect 8, wherein performing the monitoring procedure according to the one or more rate matching rules comprises: refraining from monitoring an SPS-PDSCH occasion associated with the SPS-PDSCH of a plurality of SPS-PDSCH occasions based at least in part on the second message indicating the deactivation of the at least one SSB.

Aspect 10: The method of any of aspects 8 through 9, wherein performing the monitoring procedure according to the one or more rate matching rules comprises: refraining from monitoring a plurality of SPS-PDSCH occasions based at least in part on the second message indicating the deactivation of the at least one SSB, wherein the SPS-PDSCH is associated with at least one SPS-PDSCH occasion of the plurality of SPS-PDSCH occasions.

Aspect 11: The method of any of aspects 1 through 10, wherein performing the monitoring procedure according to the one or more rate matching rules comprises: performing, based at least in part on the second message indicating the activation of the at least one SSB, rate matching on the portion of the first set of resources associated with the at least one SSB at least partially overlapping the second set of resources allocated for the downlink transmission.

Aspect 12: The method of any of aspects 1 through 11, wherein performing the monitoring procedure according to the one or more rate matching rules comprises: refraining from performing rate matching on the portion of the first set of resources associated with the at least one SSB at least partially overlapping the second set of resources allocated for the downlink transmission based at least in part on the second message indicating the activation of the at least one SSB and based at least in part on a third message scheduling the downlink transmission being a multi-cast transmission.

Aspect 13: The method of any of aspects 1 through 12, wherein performing the monitoring procedure according to the one or more rate matching rules comprises: monitoring for the downlink transmission during one or more monitoring occasions based at least in part on the second message indicating the deactivation of the at least one SSB, wherein at least one monitoring occasion of the one or more monitoring occasions is associated with the second set of resources at least partially overlapping with the first set of resources allocated for the SSB.

Aspect 14: The method of aspect 13, wherein monitoring for the downlink transmission comprises: monitoring a UE-specific search space for the downlink transmission.

Aspect 15: The method of any of aspects 1 through 14, wherein performing the monitoring procedure according to the one or more rate matching rules comprises: refraining from monitoring for the downlink transmission during one or more monitoring occasions based at least in part on the second message indicating the deactivation of the at least one SSB, wherein at least one monitoring occasion of the one or more monitoring occasions is associated with the second set of resources at least partially overlapping with the first set of resources allocated for the at least one SSB.

Aspect 16: The method of any of aspects 1 through 15, wherein the downlink transmission comprises an PDSCH, a SPS-PDSCH, or a DCI message.

Aspect 17: The method of any of aspects 1 through 16, wherein the second message indicates the one or more rate matching rules.

Aspect 18: The method of any of aspects 1 through 17, wherein the second message comprises a DCI message.

Aspect 19: A UE for wireless communications, comprising one or more memories storing processor-executable code, and one or more processors coupled with the one or more memories and individually or collectively operable to execute the code to cause the UE to perform a method of any of aspects 1 through 18.

Aspect 20: A UE for wireless communications, comprising at least one means for performing a method of any of aspects 1 through 18.

Aspect 21: A non-transitory computer-readable medium storing code for wireless communications, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message indicating a configuration for a plurality of synchronization signal blocks (SSBs);
receive a second message indicating an activation or a deactivation of at least one SSB of the plurality of SSBs of the configuration, wherein the at least one SSB is associated with a first set of resources at least partially overlapping with a second set of resources allocated for a downlink transmission; and
perform a monitoring procedure according to one or more rate matching rules, wherein the one or more rate matching rules are based at least in part on the activation or the deactivation of the at least one SSB and based at least in part on the first set of resources at least partially overlapping with the second set of resources allocated for the downlink transmission.

2. The UE of claim 1, wherein, to receive the second message, the one or more processors are individually or collectively operable to execute the code to cause the UE to:
receive the second message indicating the activation or the deactivation of the at least one SSB, wherein the second message comprises a dynamic indication and is associated with a first periodicity different than a second periodicity associated with a system information block (SIB) message.

3. The UE of claim 1, wherein the UE has a capability to decode the second message indicating the activation or the deactivation of the at least one SSB, and wherein, to perform the monitoring procedure, the one or more processors are individually or collectively operable to execute the code to cause the UE to:
perform the monitoring procedure according to the one or more rate matching rules based at least in part on the capability of the UE to decode the second message.

4. The UE of claim 1, wherein, to perform the monitoring procedure according to the one or more rate matching rules, the one or more processors are individually or collectively operable to execute the code to cause the UE to:
perform, based at least in part on the second message indicating the deactivation of the at least one SSB, rate matching on a portion of the first set of resources associated with the at least one SSB that at least partially overlaps the second set of resources allocated for the downlink transmission.

5. The UE of claim 4, wherein, to perform the rate matching, the one or more processors are individually or collectively further operable to execute the code to cause the UE to:
perform the rate matching on the portion of the first set of resources based at least in part on a third message scheduling the downlink transmission being a multi-cast transmission.

6. The UE of claim 1, wherein, to perform the monitoring procedure according to the one or more rate matching rules, the one or more processors are individually or collectively operable to execute the code to cause the UE to:
refraining, based at least in part on the second message indicating the deactivation of the at least one SSB, from performing rate matching on a portion of the first set of resources associated with the at least one SSB that at least partially overlaps the second set of resources allocated for the downlink transmission.

7. The UE of claim 6, wherein, to refrain from performing the rate matching, the one or more processors are individually or collectively further operable to execute the code to cause the UE to:
refrain from performing the rate matching on the portion of the first set of resources based at least in part on a third message scheduling the downlink transmission being UE-specific.

8. A method for wireless communications at a user equipment (UE), comprising:
receiving a first message indicating a configuration for a plurality of synchronization signal blocks (SSBs);
receiving a second message indicating an activation or a deactivation of at least one SSB of the plurality of SSBs of the configuration, wherein the at least one SSB is associated with a first set of resources at least partially overlapping with a second set of resources allocated for a downlink transmission; and
performing a monitoring procedure according to one or more rate matching rules, wherein the one or more rate matching rules are based at least in part on the activation or the deactivation of the at least one SSB and based at least in part on the first set of resources at least partially overlapping with the second set of resources allocated for the downlink transmission.

9. The method of claim 8, wherein the downlink transmission comprises a semi-persistent scheduling (SPS)-physical downlink shared channel (PDSCH).

10. The method of claim 9, wherein performing the monitoring procedure according to the one or more rate matching rules comprises:
refraining from monitoring an SPS-PDSCH occasion associated with the SPS-PDSCH of a plurality of SPS-PDSCH occasions based at least in part on the second message indicating the deactivation of the at least one SSB.

11. The method of claim 9, wherein performing the monitoring procedure according to the one or more rate matching rules comprises:
refraining from monitoring a plurality of SPS-PDSCH occasions based at least in part on the second message indicating the deactivation of the at least one SSB, wherein the SPS-PDSCH is associated with at least one SPS-PDSCH occasion of the plurality of SPS-PDSCH occasions.

12. The method of claim 8, wherein performing the monitoring procedure according to the one or more rate matching rules comprises:
performing, based at least in part on the second message indicating the activation of the at least one SSB, rate matching on a portion of the first set of resources associated with the at least one SSB at least partially overlapping the second set of resources allocated for the downlink transmission.

13. The method of claim 8, wherein performing the monitoring procedure according to the one or more rate matching rules comprises:
refraining from performing rate matching on a portion of the first set of resources associated with the at least one SSB at least partially overlapping the second set of resources allocated for the downlink transmission based at least in part on the second message indicating the activation of the at least one SSB and based at least in part on a third message scheduling the downlink transmission being a multi-cast transmission.

14. The method of claim 8, wherein performing the monitoring procedure according to the one or more rate matching rules comprises:
monitoring for the downlink transmission during one or more monitoring occasions based at least in part on the second message indicating the deactivation of the at least one SSB, wherein at least one monitoring occasion of the one or more monitoring occasions is associated with the second set of resources at least partially overlapping with the first set of resources allocated for the SSB.

15. The method of claim 14, wherein monitoring for the downlink transmission comprises:
monitoring a UE-specific search space for the downlink transmission.

16. A non-transitory computer-readable medium storing code for wireless communications, the code comprising instructions executable by one or more processors to:
receive a first message indicating a configuration for a plurality of synchronization signal blocks (SSBs);
receive a second message indicating an activation or a deactivation of at least one SSB of the plurality of SSBs of the configuration, wherein the at least one SSB is associated with a first set of resources at least partially overlapping with a second set of resources allocated for a downlink transmission; and
perform a monitoring procedure according to one or more rate matching rules, wherein the one or more rate matching rules are based at least in part on the activation or the deactivation of the at least one SSB and based at least in part on the first set of resources at least partially overlapping with the second set of resources allocated for the downlink transmission.

17. The non-transitory computer-readable medium of claim 16, wherein the instructions to perform the monitoring procedure according to the one or more rate matching rules are executable by the one or more processors to:
refrain from monitoring for the downlink transmission during one or more monitoring occasions based at least in part on the second message indicating the deactivation of the at least one SSB, wherein at least one monitoring occasion of the one or more monitoring occasions is associated with the second set of resources at least partially overlapping with the first set of resources allocated for the at least one SSB.

18. The non-transitory computer-readable medium of claim 16, wherein the downlink transmission comprises a physical downlink shared channel (PDSCH), a semi-persistent scheduling (SPS)-PDSCH, or a downlink control information (DCI) message.

19. The non-transitory computer-readable medium of claim 16, wherein the second message indicates the one or more rate matching rules.

20. The non-transitory computer-readable medium of claim 16, wherein the second message comprises a downlink control information (DCI) message.
